(19) United States
(12) Patent Application Publication
(10) Pub. No.: US 2018/0132451 A1
(43) Pub. Date: May 17, 2018

(54) PET CARE STATION

(71) Applicant: Forever Stainless Steel, Omaha, NE (US)

(72) Inventors: Mark S. Arndt, Omaha, NE (US); Jeanne L. Caples, Omaha, NE (US)

(21) Appl. No.: 15/814,159

(22) Filed: Nov. 15, 2017

Related U.S. Application Data
(60) Provisional application No. 62/422,282, filed on Nov. 15, 2016.

(51) Int. Cl. A01K 13/00; A01K 15/04

(52) U.S. Cl. CPC A01K 13/00; A01K 15/04

(57) ABSTRACT

Embodiments of a pet grooming station include a tabletop and a surround formed from end walls and a rear wall that partially enclose an animal from the immediate environment. Vertically spaced-apart tethering points extend inwardly from the end walls and a restraining bar extends along a length of the rear wall. The tethering points and restraining bar provide various combinations of securement locations to which leashes or tethers may be anchored. One or more pads may be coupled with the tabletop for the comfort and traction of the animal.

### CROSS-REFERENCE TO RELATED APPLICATIONS

The present application is a non-provisional of U.S. Provisional Patent Application Ser. No. 62/422,282, titled “Pet Grooming Station”, filed Nov. 15, 2016, which is incorporated herein as if set out in full.

### BACKGROUND

Tabletops are used by amateur and professional animal caregivers to groom, inspect, and treat various animals. However, ordinary tabletops present a number of challenges. Tables generally have planar surfaces that terminate at peripheral edges. This affords the animal with a 360 degree view of its surroundings, which may include other, playful or aggressive animals. This can be an attractive nuisance to the animal, keeping it in constant states of stress and movement. It also provides the animal with nearly limitless directions in which the animal can try to escape. Such escape attempts can be frustrating, time consuming, and potentially dangerous to the animal and the user. Moreover, the open nature of the tabletop allows for hair, water, and other debris to be shaken or shed from the animal onto everything and everyone near the tabletop. This increases cleanup time and the stress of those in the surroundings.

Previously known grooming tables suffer from complicated or inadequate methods of restraining the animals. Such tables have included an arm that extends upwardly from an edge of the tabletop. The arms are adapted to receive a free end of the pet restraint. However, to accommodate pets of different sizes, it is necessary to adjust the height of the arm by loosening and tightening a clamp that attaches the arm to the table. The mechanics of adjusting the arm's height can be awkward and confusing for professionals and non-professionals alike, especially when they are struggling to control an animal on top of the tabletop. It can also be hazardous for both the animal and the user if the clamp is not tightened correctly, which can cause the arm to fall suddenly while it is still secured to the animal. Where such equipment is used correctly, the animal remains in an unsafe position. The animal may leap from the table while remaining tethered to the arm on the table, causing serious injury.

Attempts have been made to use a bathing tub for grooming the animal. However, the tub has typically just been used to wash the animal and is wet. This presents slippery surfaces and can make the animal unnecessarily cold. Even if the tub hasn't been used, the sunken nature of the tub basin will limit the users easy access to the lower half of the animal, making grooming operations difficult.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

The present disclosure provides a pet grooming station having a tabletop with opposite end portions, opposite side portions and an upper surface. A surround, defined by a pair of opposing end walls and a rear wall, is provided to extend upwardly from the tabletop. A support shelf may be provided that is removably coupled with an upper edge of the surround to hold a variety of grooming and/or treatment supplies. In at least one embodiment forward-facing edges of the end walls are angled to slope rearwardly toward the rear wall.

The pet grooming station further includes at least one tethering point that extends inwardly from the surround above the tabletop. In some embodiments, the plurality of tethering points extend inwardly from the surround at different heights above the tabletop. In various embodiments, the tethering point includes a restraining bar having a length that is spaced upwardly from the tabletop. The restraining bar may include a plurality of individual tether points that are positioned along the length of the restraining bar or a single, elongated tether point that extends along the length of the restraining bar.

In at least one embodiment the pet grooming station includes a deformably resilient pad positioned on the upper surface of the tabletop. In particular embodiments, the deformably resilient pad is at least partially disposed within a recess formed in the upper surface of the tabletop. The deformably resilient pad may be provided with a sufficient thickness that it stands proud of the upper surface of the tabletop when the deformably resilient pad is disposed within the recess.

In a method of use, an animal is placed on the tabletop of the pet grooming station. One end of a restraining device it operatively coupled to at least one tethering point, extending inwardly from the surround above the tabletop and an opposite end of the restraining device is secured with the animal. In particular embodiments the tethering point is a restraining bar having a length that is spaced upwardly from the tabletop. In such embodiments, an individual can turning the animal within the surround to face in an opposite direction by allowing the restraining device to slide along the length of the restraining bar. In other embodiments, the individual may uncoupling the end of the restraining device from the tethering point and couples the end of the restraining device to a second tethering point, extending inwardly from the surround above the tabletop. In particular embodiments, the tethering points are positioned at different heights above the tabletop.

These and other aspects of the present system and method will be apparent after consideration of the Detailed Description and Figures herein. It is to be understood, however, that the scope of the invention shall be determined by the claims as issued and not by whether given subject matter addresses any or all issues noted in the Background or includes any features or aspects recited in this Summary.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 depicts a perspective view of one embodiment of the pet grooming station of the present technology.

FIG. 2 depicts a front elevation view of an embodiment of the pet grooming station of the present technology.

FIG. 3 depicts an isometric view of one embodiment of a tethering loop that may be made a part of various embodiments of the pet grooming station of the present technology.

FIG. 4 depicts a top plan view of an embodiment of the pet grooming station of the present technology.

FIG. 5 depicts an end view of an embodiment of the pet grooming station of the present technology.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

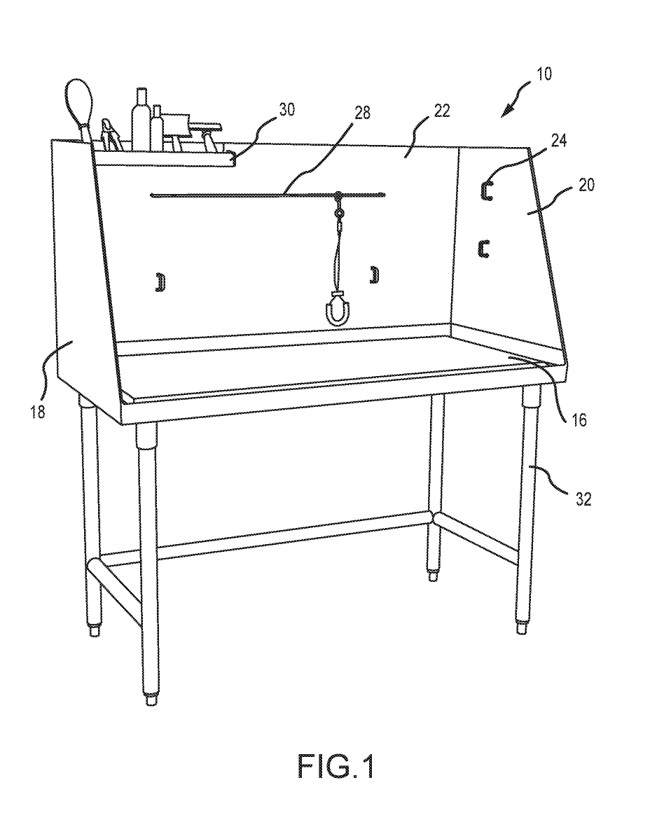

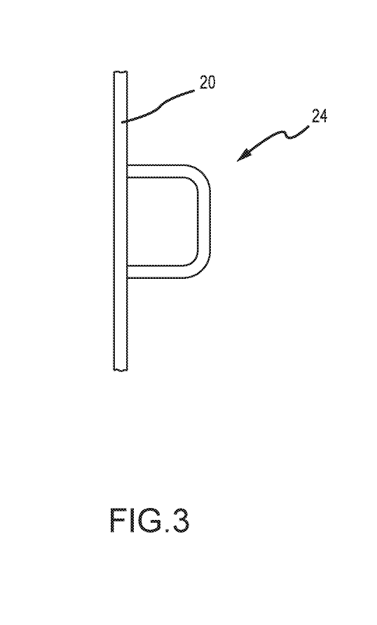

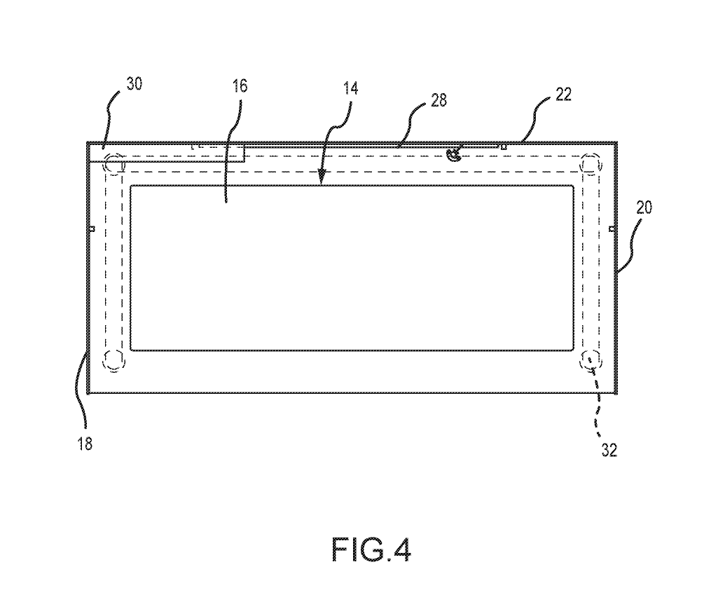

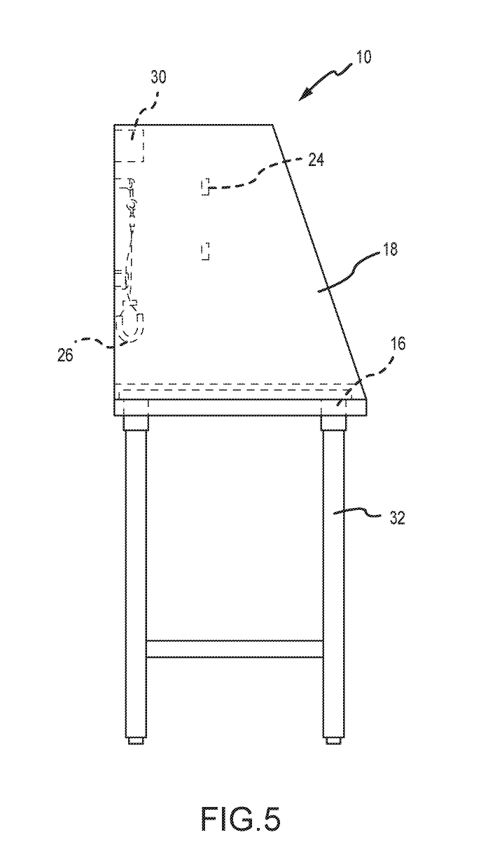

With reference to FIGS. 1-5, embodiments of the pet grooming station 10 include a tabletop 12 having opposite ends and opposite sides. While the tabletop 12 is depicted as having a rectangular peripheral edge, it is contemplated that the tabletop 12 may be square, round, obround, or other polygonal or round shape, depending on the intended use. In some embodiments, the tabletop 12 may have a peripheral edge that is made of a combination of straight and curved sides.

In various embodiments, the tabletop 12 includes a recess 14 that is sized to receive a pad 16 to give pets traction and comfort. In particular embodiments, one or more pads 16 are shaped to be removably positioned within the recess 14. In some embodiments, the pad 16 will have a sufficient thickness that it will stand proud of the tabletop 12 surface when the pad 16 is disposed within the recess. In other embodiments, a top surface of the pad 16 may be positioned to be flush with the tabletop 12 surface. Embodiments of the pad 16 are formed from a deformably resilient material that will provide a level of comfort to the animal being supported thereon. The material may be a water-resistant material such as a closed-cell foam rubber. However, it is contemplated that other natural and synthetic materials may provide a suitable pad 16 for use with the present technology. In at least one specific embodiment, however, a closed cell nitrile foam rubber pad 16 is used having a non-slip surface texture formed into its opposite surfaces. This material is used for its ability to resist stains, odors, and liquids. Moreover, such materials resist damage by detergents, disinfectants, and bleach. Such materials may also be desirable for their ability to resist wear and tear caused by engagement with the animals' feet and nails. In some embodiments, a plurality of apertures may be provided to penetrate the pad 16 to enable fluids to freely pass from an upper surface of the pad 16 to the tabletop 12. The removable nature of the pad 16 allows the tabletop 12 and the pad 16 to be easily cleaned or replaced after use.

The pet grooming station 10 is provided with a surround, which includes end walls 18 and 20 that extend upwardly from the opposite ends of the tabletop 12. In some embodiments, forward-facing edges of the end walls 18 and 20 are angled to slope rearwardly. In particular embodiments, the angle of the forward-facing edges begins at or near the surface of the tabletop 12. In other embodiments, the angle may begin at a point that is spaced above the surface of the tabletop 12. The forward facing edges terminate at an upper edge portion of the end walls 18 and 20. Particular aspects of the angled, forward-facing edges impart a greater rigidity throughout the end walls 18 and 20. Other aspects of the angled, forward-facing edges enable a greater degree of peripheral vision, beyond the ends of the pet grooming station 10, for users without limiting the physical and visual confinement of an animal on the tabletop 12.

A rear wall 22 extends upwardly from a side portion of the tabletop 12 and between the end walls 18 and 20. The end walls 18 and 20 and the and rear wall 22, together, define the surround. In various embodiments, the end walls have a width of approximately 24 inches and a height of approximately 26 inches. Embodiments of the rear wall 22 have a width of 52 inches and a height of 26 inches. In such embodiments, it is contemplated that the surround will be dimensioned to comfortably accommodate most animals that would be groomed or examined on the pet grooming station 10. It is contemplated, however, that the end walls 18 and 20 and the rear wall 22 could be sized according to particular needs and animal sizes/types. The surround, extending along three sides of the tabletop 12, can give the person attending to the animal better control. The animal has only one way out, rather than having a choice of escape routes. Moreover the three-sided surround blocks noise and visual distractions from the animal on three sides, which can diminish unwanted interaction with other animals in the same general area. This provides a greater sense of confinement and makes it less likely that the animal will consider trying to escape. The three-sided further helps to keep pet hair, and water that the animal shakes free, better confined within the footprint of the tabletop.

In many embodiments, the pet grooming station 12 will not include a forward wall that extends upwardly from the tabletop 12, between the end walls 18 and 20. In some embodiments, a forward side edge of the tabletop 12 will terminate, flush with the surface of the tabletop 12. In other embodiments, the tabletop 12 will include a raised edge at the forward side edge of the tabletop 12. In such embodiments, the raised edge may extend upwardly approximately one half an inch above the surface of the tabletop 12. The raised edge may help in retaining one or more pads 16 where a recess 14 is not formed into the tabletop 12. However, the raised edge at the forward side edge of the tabletop 12 will not, in combination with the surround, be sufficient to define a tub area above the surface of the tabletop 12. In some embodiments, the raised edge at the forward side edge of the tabletop 12 will be formed from a plurality of linearly spaced-apart segments or otherwise be formed with openings that prevent the retention of fluid on top of the tabletop 12.

In some embodiments, it is contemplated that a roof portion (not depicted) may be positioned above the tabletop 12 and operatively connected to one or more of the opposite end walls 18 and 20 and rear wall 22. Such a roof portion may be formed from a rigid material, such as stainless steel or various plastics. In other embodiments, the roof portion may be formed from a flexible material, such as one or more fabrics, open or closed-cell foam materials, and the like. Regardless, the roof may be removable or permanently secured with the surround. In other embodiments, the roof may be provided to pivot open from the rear wall 22 to a wide array of different angles from a horizontal position above the tabletop 12 to fully open, such as extending straight up, in planar alignment with the rear wall 22, to resting adjacent the rear wall 22 in parallel alignment therewith.

With reference to FIGS. 1-3, embodiments of the pet grooming station 10 include one or more tethering points 24 that are secured to one or more of the end walls 18 and 20 and the rear wall 22. In particular embodiments, a plurality of tethering points 24 extend outwardly from one or both of the end walls 18 and 20, vertically spaced from one another. Such embodiments provide places to attach a restraining device 26, such as a leash, tether, or other restraint at a plurality of different heights. This allows for a range of pet sizes to be appropriately restrained. While the tethering points 24 are depicted in FIGS. 1-3 as being closed-loops, it is contemplated that the tethering points could be formed to have openings through which loops of a restraining device 26 may be passed to secure the tethering point 24 and restraining device 26 with one another. In other embodiments, the opening in one or more of the tethering points 24 could be provided with a closure or catch that is pivotably movable between open and closed positions to allow the restraining devices 26 to be easily engaged and disengaged with the tethering points 24 while remaining secured when desired.

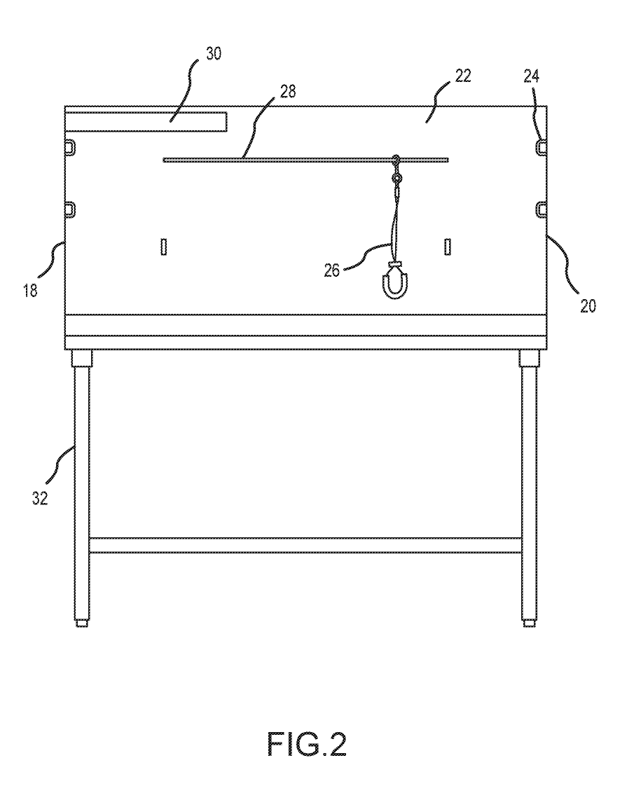

With further reference to FIGS. 1 and 2, an elongated restraining bar 28 extends outwardly from the rear wall 22, such that it runs along a length of the rear wall 22 at a fixed height above the tabletop 12. In some embodiments, the restraining bar 28 includes one or more tethering loops along the length of the restraining bar 28. In this manner, pets of different lengths may be easily restrained at one or more points along a length of the pet grooming station 10. In other embodiments, the restraining bar provides one continuous loop along a length of the restraining bar 28, which allows a restraining device 26 to slide along the length of the restraining bar 28. This enables an individual to easily turn the animal within the surround to face in opposite directions and provide easy access to both sides of the animal without uncoupling the restraining device 26. It is contemplated that one or more embodiments of the pet grooming station 10 will include one or more tethering points 24 and a restraining bar 28. In particular embodiments of use, one or more tethering points 24 and a restraining bar 28 may be used simultaneously to restrain a pet.

With reference to FIG. 1, an upper supply shelf 30 may be provided to extend outwardly from one or more of the end walls 18 and 20, and rear wall 22. The supply shelf 30 may be dimensioned to support a variety of grooming tools or other instruments or supplies. The supply shelf 30 may be removably coupled to the upper edge portion of an end wall 18 or 20 or the rear wall 22. In such embodiments, hooks or other mechanical supports extend rearwardly from the support shelf 30. It is also contemplated that embodiments of the pet grooming station 10 could include a lower shelf (not depicted) beneath the tabletop 12 to store additional supplies or equipment. Other embodiments include a rack (not depicted) beneath the tabletop to accommodate a pet dryer.

With reference to FIGS. 1, 2, and 5, embodiments of the pet grooming station 10 include one or more legs 32 of various possible configurations that depend downwardly from the tabletop 12 to support the tabletop 12 in an elevated position above a ground level. It is contemplated that the legs 32 could be provided in various lengths or length-adjustable, such as by infinitely, incrementally telescoping sections that are selectively locked into place by one of various mechanical fasteners, to vary the height of the tabletop 12 from the ground level. In some embodiments, it is contemplated that a roof portion (not depicted) may be positioned above the bottom portion 22 and operatively connected to one or more of the opposite side portions 14 and 16, and opposite end portions 18 and 20. In other embodiments, a ramp may extend from a side portion to a ground level.

The pet grooming station 10 could be used for drying, brushing, and grooming of various different pets. In at least one method of use, a pet is placed on the tabletop 12 or pad 16 of the pet grooming station 10. A restraining device 26, such as leash or tether may be secured at one end to a collar or harness worn by the animal. The other end of the leash or tether may then be secured to a tethering point 24 or restraining bar 28. In some embodiments, additional restraining devices 26 may be used to secure the animal to other tethering points 24 or locations along the restraining bar 28. The user may then groom or otherwise inspect or treat the animal. The restraining device 26 may be uncoupled from the tethering point 24 or restraining bar 28 in order to turn the animal to face in an opposite direction within the surround. The user then simply secures the restraining device 26 with other tethering points 24 or tethering loops along the restraining bar 28.

Although the technology has been described in language that is specific to certain structures, materials, and methodological steps, it is to be understood that the invention defined in the appended claims is not necessarily limited to the specific structures, materials, and/or steps described. Rather, the specific aspects and steps are described as forms of implementing the claimed invention. Since many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. A pet grooming station, comprising:
a tabletop having opposite end portions, opposite side portions and an upper surface;
a surround, defined by a pair of opposing end walls and a rear wall that extend upwardly from the tabletop; and
at least one tethering point extending inwardly from the surround above the tabletop.

2. The pet grooming station of claim 1 comprising a plurality of tethering points extending inwardly from the surround above the tabletop; the plurality of tethering points being vertically spaced from one another above the tabletop.

3. The pet grooming station of claim 2 wherein at least two of the plurality of tethering points extend inwardly from the surround at different heights above the tabletop.

4. The pet grooming station of claim 3 wherein the at least two of the plurality of tethering points extend inwardly from at least one of the end walls.

5. The pet grooming station of claim 1 wherein the plurality of tethering points are comprised of a restraining bar having a length that is spaced upwardly from the tabletop.

6. The pet grooming station of claim 4 wherein the restraining bar extends inwardly from the rear wall of the surround.

7. The pet grooming station of claim 4 wherein the restraining bar includes a plurality of individual tether points that are positioned along the length of the restraining bar.

8. The pet grooming station of claim 4 wherein the restraining bar includes a single, elongated tether point that extends along the length of the restraining bar.

9. The pet grooming station of claim 1 wherein forward-facing edges of the end walls are angled to slope rearwardly toward the rear wall.

10. The pet grooming station of claim 1 further comprising a deformably resilient pad positioned on the upper surface of the tabletop.

11. The pet grooming station of claim 10 wherein the deformably resilient pad is at least partially disposed within a recess formed in the upper surface of the tabletop.

12. The pet grooming station of claim 11 wherein the deformably resilient pad has a sufficient thickness that it stands proud of the upper surface of the tabletop when the deformably resilient pad is disposed within the recess.

13. The pet grooming station of claim 1 further comprising a support shelf that is removably coupled with an upper edge of the surround.

14. A method of securing objects for washing, comprising:
placing an animal on a tabletop of the pet grooming station, having a surround, defined by a pair of opposing end walls and a rear wall that extend upwardly from the tabletop;
operatively coupling one end of a restraining device to at least one tethering point, extending inwardly from the surround above the tabletop; and
operatively securing an opposite end of the restraining device with the animal.

15. The method of claim 14 wherein the at least one tethering point is comprised of a restraining bar having a length that is spaced upwardly from the tabletop, the method further comprising the step turning the animal within the surround to face in an opposite direction by allowing the restraining device to slide along the length of the restraining bar.

16. The method of claim 14 further comprising the step of placing the animal on top of a deformably resilient pad positioned on the upper surface of the tabletop.

17. The method of claim 14 further comprising the step of uncoupling the end of the restraining device from the at least one tethering point and operatively coupling the end of the restraining device to a second tethering point, extending inwardly from the surround above the tabletop.

18. The method of claim 17 wherein the at least one tethering point and the second tethering point are positioned at different heights above the tabletop.

19. The method of claim 17 wherein the at least one tethering point and the second tethering point are positioned to extend inwardly from different walls of the surround.

20. The method of claim 17 wherein the second tethering point is a restraining bar having a length that is spaced upwardly from the tabletop.
